(19) United States
(12) Patent Application Publication
(10) Pub. No.: US 2012/0210436 A1
(43) Pub. Date: Aug. 16, 2012

(54) SYSTEM AND METHOD FOR FINGERPRINTING IN A CLOUD-COMPUTING ENVIRONMENT

(76) Inventor: Alan Rouse, Lawrenceville, GA (US)

(21) Appl. No.: 13/026,429

(22) Filed: Feb. 14, 2011

(51) Int. Cl. G06F 21/00

(52) U.S. Cl. 726/26

(57) ABSTRACT

A system and method for uniquely fingerprinting an execution environment instance in a cloud-computing environment in which an application is assigned to the execution environment instance, and a license key is required for the application to access a desired licensed feature. The application requests a fingerprint certificate from a cloud infrastructure management unit via the application's execution environment instance. The management unit identifies the fingerprint assigned to the execution environment instance, digitally signs a fingerprint certificate, and assigns an expiration timestamp. An application programming interface (API) sends the signed certificate and timestamp back to the application. The application verifies the digital signature and the timestamp and utilizes the fingerprint certificate to request a license key from a licensing system. The licensing system verifies the fingerprint certificate before generating the license key, and the application verifies that the license key matches the fingerprint before accessing the licensed feature.

### CROSS-REFERENCE TO RELATED APPLICATIONS

NOT APPLICABLE

### STATEMENT REGARDING FEDERALLY SPONSORED RESEARCH OR DEVELOPMENT

NOT APPLICABLE

### REFERENCE TO SEQUENCE LISTING, A TABLE, OR A COMPUTER PROGRAM LISTING COMPACT DISC APPENDIX

NOT APPLICABLE

### BACKGROUND

The present invention relates to computer processing systems. More particularly, and not by way of limitation, the present invention is directed to a system and method for uniquely identifying (fingerprinting) an execution environment instance in a cloud-computing environment.

Cloud computing is an approach to sharing computing resources over the Internet. One emerging area of cloud computing is called Infrastructure-as-a-service, in which a host provider (for example, Amazon) provides virtual server instances on which customers can run applications on demand. The customer benefits by sharing the cost of the host's computing center and system management expertise with other customers of the cloud. Companies are considering these cloud computing environments as a potential cost-efficient way of running mission-critical systems.

System fingerprinting is a technique of uniquely identifying a particular execution environment, usually for the purpose of licensing and anti-piracy protection. Many techniques of fingerprinting hardware systems are used, including Media Access Control (MAC) addresses, Central Processing Unit identifiers (CPU IDs) and hardware ID plug-in devices (“dongles”). Virtual computing makes fingerprinting more difficult, since a virtual machine can be copied and it contains all the information commonly used for fingerprinting, defeating the uniqueness property of the fingerprint. Fingerprinting can still effectively provide a unique identity in a virtual environment if the virtualization platform is linked to a physical hardware module such as a hardware dongle or Trusted Platform Module (TPM).

### SUMMARY

A problem with cloud computing is that it does not provide a secure way to uniquely identify a particular execution environment instance. In cloud environments, it is important to be able to move applications around within the cloud on an as-needed basis to manage resources efficiently. So tying the application to physical hardware is not desirable. The present invention provides a solution to this problem.

The present invention provides in the cloud infrastructure, the capability to assign an identity to each instance of execution environment. An Application Programming Interface (API) enables applications to query the identity of their environment, and to perform a cryptographically strong challenge-response protocol with the cloud infrastructure to prove that the claimed fingerprint actually represents the current environment.

In one embodiment, the present invention is directed to a method of uniquely fingerprinting an execution environment instance in a cloud-computing environment in which an application is assigned to the execution environment instance, and license keys are required for the application to access desired licensed features. The method includes the steps of obtaining by the application, a fingerprint certificate from a cloud infrastructure management unit; and utilizing the fingerprint certificate by the application to obtain from a licensing system, a license key for a desired licensed feature. The fingerprint certificate may be digitally signed by the cloud infrastructure management unit and may be verified by the application and the licensing system before the license key is obtained. The cloud infrastructure management unit may also include an expiration timestamp with the fingerprint certificate, and the application may verify that the expiration timestamp has not expired.

In another embodiment, the present invention is directed to a cloud infrastructure management unit in a cloud-computing environment. The management unit includes a database for storing fingerprint certificates for a plurality of execution environment instances; and an API for receiving requests for fingerprint certificates from applications and for sending fingerprint certificates to the applications in response.

In another embodiment, the invention is directed to a cloud-computing system. The system includes a processor; a memory for storing computer program instructions for execution by the processor; a cloud infrastructure management unit; a plurality of execution environment instances in communication with the cloud infrastructure management unit; an application assigned to a given execution environment instance; and a licensing system in communication with the application. When the processor executes the computer program instructions, the processor causes the following steps to be performed: the application requesting a fingerprint certificate from the given execution environment instance when the application desires to utilize a particular feature; the given execution environment instance requesting the fingerprint certificate from the cloud infrastructure management unit; the cloud infrastructure management unit identifying the requested fingerprint certificate, applying a digital signature of the cloud-computing system to the requested fingerprint certificate, and utilizing an API to send the digitally signed requested fingerprint certificate to the application via the given execution environment instance; the application verifying the digital signature of the cloud-computing system; and upon positive verification of the digital signature, the application utilizing the fingerprint certificate to obtain from the licensing system, a license key associated with the particular feature.

The present invention enables customers of cloud computing services to apply strong antipiracy licensing features based on a fingerprint of the execution environment where the application runs, without sacrificing flexibility of the cloud to move execution around to maximize effective use of resources.

### BRIEF DESCRIPTION OF THE DRAWINGS

In the following section, the invention will be described with reference to exemplary embodiments illustrated in the figures, in which:

FIGS. 1A-1B are portions of a flow chart of an exemplary embodiment of an inventive method by which an application obtains and verifies a fingerprint certificate and obtains license keys for the fingerprint;

FIG. 2 is a flow chart of an exemplary embodiment of an inventive method by which the application verifies a license key associated with a particular feature; and

FIG. 3 is a simplified block diagram of an exemplary embodiment of the system of the present invention.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention. Additionally, it should be understood that the invention may be implemented in hardware or in a combination of hardware and software. For example, one or more computers or processors may perform the steps of the method of the present invention when executing computer program instructions stored in one or more program memories.

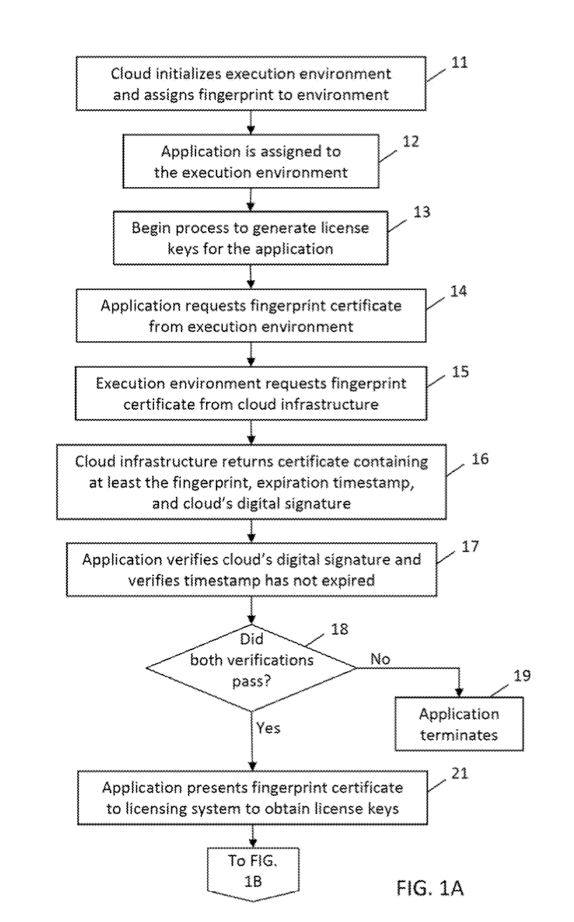

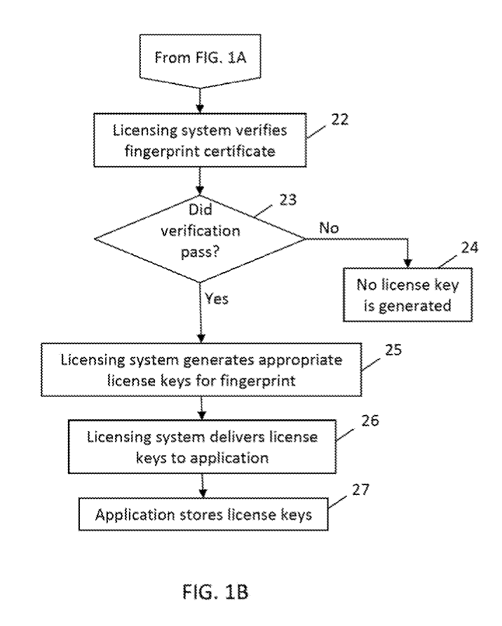

FIGS. 1A-1B are portions of a flow chart of an exemplary embodiment of an inventive method by which an application obtains and verifies a fingerprint certificate and obtains license keys for the fingerprint. Referring to FIG. 1A, at step 11, the cloud initializes an execution environment and assigns an identity (fingerprint) to the environment. At step 12, an application is assigned to that instance of execution environment. At step 13, a process is begun to generate license keys for the application. At step 14, the application requests a fingerprint certificate from the execution environment. At step 15, the execution environment requests the fingerprint certificate from the cloud infrastructure. At step 16, the cloud infrastructure returns a certificate containing (at least) the fingerprint, an expiration timestamp, and the cloud's digital signature on the certificate.

At step 17, the application verifies the cloud's digital signature using the cloud's trusted public key, and also verifies the expiration timestamp has not elapsed. At step 18, it is determined whether both of the verifications passed. If not, the method moves to step 19 where the application terminates. If both verifications passed, the method moves to step 21 where the application presents the fingerprint certificate to a licensing system to obtain license keys.

The method then moves to FIG. 1B. At step 22, the licensing system verifies the fingerprint certificate. At step 23, it is determined whether the verification passed. If not, the method moves to step 24 where no license key is generated. If the verification passed, the method moves to step 25 where the licensing system generates license keys for the authentic fingerprint, based on what features and the like are appropriate for the instance of the application running in that particular execution environment. At step 26, the license keys are delivered to the application. At step 27, the application stores the keys for later retrieval.

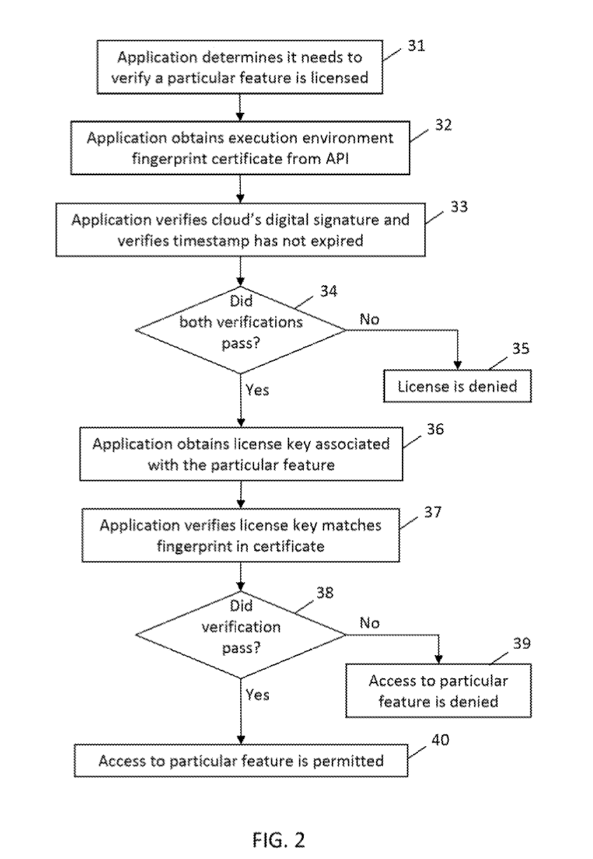

FIG. 2 is a flow chart of an exemplary embodiment of an inventive method by which the application verifies a license key associated with a particular feature. This method may be performed each time the application needs to verify that a particular feature is licensed. At step 31, the application determines it needs to verify that a particular feature is licensed. At step 32, the application obtains the execution environment's fingerprint certificate from an API that enables applications to query the identity of their environment, and to perform a cryptographically strong challenge-response protocol with the cloud infrastructure to prove that the claimed fingerprint actually represents the current environment. At step 33, the application verifies the cloud's digital signature on the certificate, and verifies the expiration timestamp has not elapsed. At step 34, it is determined whether both of the verifications passed. If not, the method moves to step 35 where the license is denied. If both verifications passed, the method moves to step 36 where the application obtains the license key associated with the particular feature in question. At step 37, the application verifies that the license key matches the fingerprint in the certificate. How this is done varies according to the licensing system being used. But in general, it is a proof that the license key was issued for the system matching that fingerprint. At step 38, it is determined whether the verification passed. If not, the method moves to step 39 where access to the particular feature is denied. If the verification passed, the method moves to step 40 where access to the particular feature is permitted.

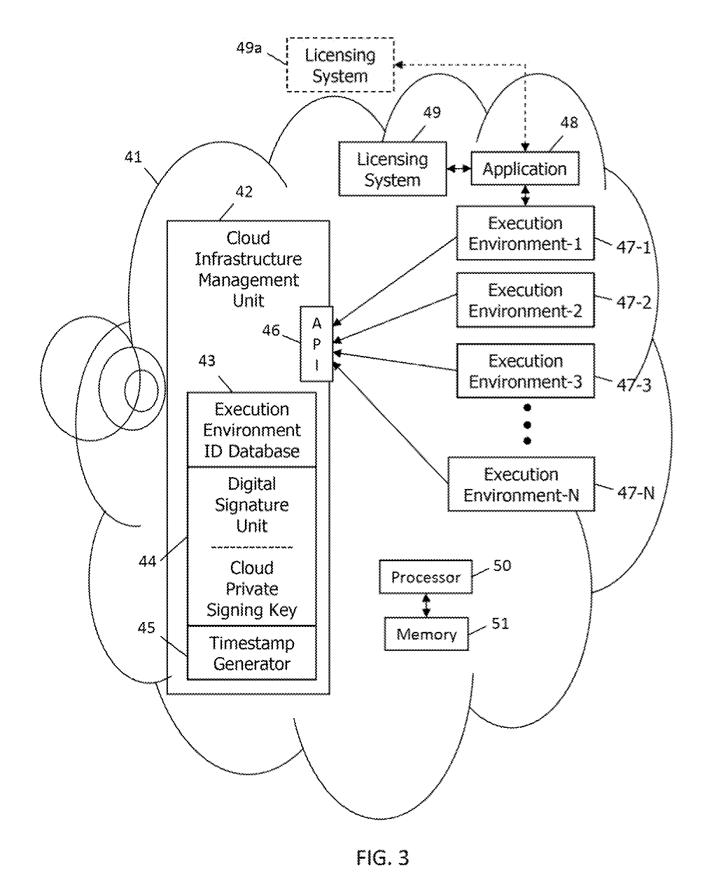

FIG. 3 is a simplified block diagram of an exemplary embodiment of the system of the present invention. The system is implemented within a cloud computing environment 41. A Cloud Infrastructure Management unit 42 includes an Execution Environment ID Database 43 for providing fingerprint certificates when requested by execution environments. A Cloud Private Signing Key 44 provides the digital signature on the certificates, and a Timestamp Generator 45 provides the expiration timestamp. An API 46 interfaces with various execution environments 47-1 through 47-N. As previously noted, the API enables applications to query the identity of their environment, and to perform a cryptographically strong challenge-response protocol with the cloud infrastructure to prove that the claimed fingerprint actually represents the current environment.

An application 48 is shown as being assigned to execution environment-1, thus the application requests the fingerprint certificate from execution environment-1, and execution environment-1, in turn, requests the certificate from the Cloud Infrastructure Management unit 42 via the API 46. Upon obtaining the fingerprint certificate, expiration timestamp, and digital signature, the application verifies the cloud's digital signature and timestamp, and then presents the fingerprint certificate to the licensing system 49. Upon verification of the fingerprint certificate by the licensing system, the licensing system generates license keys for the authentic fingerprint and provides the license keys to the application 48. The application repeats this process each time the application needs to verify that a particular feature is licensed.

It should be noted that the Licensing System may be located outside the cloud as depicted in FIG. 3 by the Licensing System 49a shown in phantom. This might occur in a scenario, for example, when an operator is running Ericsson components inside a cloud at a site such as Amazon. In this case, the Licensing System could be owned and operated by Ericsson outside the cloud, or even in a different cloud.

The system of the present invention may be controlled by a processor 50 executing computer program instructions stored on a memory 51. It should also be recognized that the each of the individual components of the system may include its own processor and memory for controlling the component's behavior and for performing the steps of the present invention.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed is:

1. A method of uniquely fingerprinting an execution environment instance in a cloud-computing environment in which an application is assigned to the execution environment instance, and license keys are required for the application to access desired licensed features, the method comprising the steps of:
obtaining by the application, a fingerprint certificate from a cloud infrastructure management unit; and
utilizing the fingerprint certificate by the application to obtain from a licensing system, a license key for a desired licensed feature.

2. The method according to claim 1, wherein the step of obtaining the fingerprint certificate includes:
the application requesting the fingerprint certificate from the cloud infrastructure management unit via the execution environment instance to which the application is assigned; and
the application receiving the fingerprint certificate from the cloud infrastructure management unit via the execution environment instance.

3. The method according to claim 2, wherein the step of the application receiving the fingerprint certificate includes receiving at least the fingerprint certificate, an expiration timestamp for the certificate, and a digital signature of the cloud infrastructure management unit.

4. The method according to claim 3, further comprising, before utilizing the fingerprint certificate by the application to obtain the license key, the steps of:
the application verifying the digital signature; and
the application verifying that the expiration timestamp has not expired;
wherein the application terminates when the digital is not verified or when the expiration timestamp has expired.

5. The method according to claim 4, wherein the step of verifying the digital signature includes verifying the digital signature using a trusted public key of the cloud infrastructure management unit.

6. The method according to claim 4, further comprising, after the application obtains the license key from the licensing system, verifying by the application that the license key matches the fingerprint in the certificate;
wherein access to the desired licensed feature is permitted only when the license key matches the fingerprint in the certificate.

7. The method according to claim 1, further comprising the licensing system verifying the fingerprint certificate before delivering the license keys to the application.

8. A cloud infrastructure management unit in a cloud-computing environment, comprising:
a database for storing fingerprint certificates for a plurality of execution environment instances; and
an application programming interface (API) for receiving requests for fingerprint certificates from applications and for sending fingerprint certificates to the applications in response.

9. The cloud infrastructure management unit according to claim 8, further comprising a digital signature unit for digitally signing the fingerprint certificates with a private signing key prior to the API sending the fingerprint certificates to the applications.

10. The cloud infrastructure management unit according to claim 9, further comprising a timestamp generator for generating an associated expiration timestamp for each fingerprint certificate;
wherein when an application requests a fingerprint certificate for the application's execution environment instance, the API sends to the application, a digitally signed fingerprint certificate and the certificate's associated expiration timestamp.

11. A cloud-computing system, comprising:
a processor;
a memory for storing computer program instructions for execution by the processor;
a cloud infrastructure management unit;
a plurality of execution environment instances in communication with the cloud infrastructure management unit;
an application assigned to a given execution environment instance; and
a licensing system in communication with the application;
wherein when the processor executes the computer program instructions, the processor causes the following steps to be performed:
the application requesting a fingerprint certificate from the given execution environment instance when the application desires to utilize a particular feature;
the given execution environment instance requesting the fingerprint certificate from the cloud infrastructure management unit;
the cloud infrastructure management unit identifying the requested fingerprint certificate, applying a digital signature of the cloud-computing system to the requested fingerprint certificate, and utilizing an application programming interface (API) to send the digitally signed requested fingerprint certificate to the application via the given execution environment instance;
the application verifying the digital signature of the cloud-computing system; and
upon positive verification of the digital signature, the application utilizing the fingerprint certificate to obtain from the licensing system, a license key associated with the particular feature.

12. The cloud-computing system according to claim 11, wherein the application verifies the digital signature of the cloud-computing system using a trusted public key of the cloud infrastructure management unit.

13. The cloud-computing system according to claim 11, wherein the cloud infrastructure management unit includes a database that associates fingerprint certificates with each of the plurality of execution environment instances.

14. The cloud-computing system according to claim 11, wherein the cloud infrastructure management unit also includes a timestamp generator for generating an associated expiration timestamp for each fingerprint certificate;
wherein when the application requests the fingerprint certificate, the API sends to the application, the digitally signed requested fingerprint certificate and the certificate's associated expiration timestamp.

15. The cloud-computing system according to claim 14, wherein in addition to the application verifying the digital signature of the cloud-computing system, the application also verifies that the expiration timestamp has not expired.

16. The cloud-computing system according to claim 14, wherein the licensing system is adapted to receive the fingerprint certificate from the application, verify the fingerprint certificate, generate the license key only upon positive verification of the fingerprint certificate, and send the license key to the application.

17. The cloud-computing system according to claim 16, wherein the application is adapted to verify that the license key received from the licensing system matches the fingerprint in the certificate;
wherein access to the particular feature is permitted only when the license key matches the fingerprint in the certificate.
